(19) United States
(12) Patent Application Publication
(10) Pub. No.: US 2004/0041382 A1
(43) Pub. Date: Mar. 4, 2004

(54) Inflator with a cap

(76) Inventors: Yuzo Gotoh, Himeji-shi (JP); Yasunori Iwai, Shijyonawate-shi (JP); Masayuki Nakayasu, Himeji-shi (JP)

Correspondence Address: BIRCH STEWART KOLASCH & BIRCH, PO BOX 747, FALLS CHURCH, VA, 22040-0747, US

(21) Appl. No.: 10/390,893

(22) Filed: Mar. 19, 2003

Related U.S. Application Data
(60) Provisional application No. 60/367,277, filed on Mar. 26, 2002.
(60) Provisional application No. 60/386,756, filed on Jun. 10, 2002.

(30) Foreign Application Priority Data
Mar. 19, 2002 (JP) 2002-75554
Jun. 5, 2002 (JP) 2002-163992

(51) Int. Cl. B60R 21/26

(52) U.S. Cl. 280/741

(57) ABSTRACT

The present invention provides an inflator with a cap in which the cap can be easily mounted.

An outer surface of a diffuser portion 20 including a first gas discharging port 22 is covered with a cap 40 having a second gas discharging port 45. The cap 40 is fixed at a ring groove 31 provided on the diffuser portion 20 by crimping the minimum diameter portion 41b.

### TECHNICAL FIELD TO WHICH THE INVENTION BELONGS

The present invention relates to an inflator with a cap suitable as an inflator for a curtain air bag, an inflator for a side collision air bag or the like for an automobile or the like, and an air bag apparatus using the inflator with a cap.

### BACKGROUND ART

As an inflator for inflating type safety system of an automobile, in order to optimally protect a passenger in accordance with a position of a seat in a vehicle such as driver side, a passenger side next to the driver and the like, there are known various inflators such as an inflator for a driver side, an inflator for a passenger side next to the driver, an air bag inflator for a side collision, an inflator for a curtain air bag, an inflator for a knee-bolster air bag, an inflator for an inflatable seat belt, an inflator for a tubular system and an inflator for pretensioner. Among these inflators, the inflator for a curtain air bag instantaneously inflates and develops the curtain-like air bag having a thickness of several centimeters over windows of a vehicle when the vehicle receives the impact from the side.

As related prior arts, the following documents have been known. For example, a device for inflating a flexible container using helium and hydrogen is disclosed in U.S. Pat. No. 5,527,066, a gas flow device for an air bag using a pressurized inert gas is disclosed in U.S. Pat. No. 5,782,486, an air bag apparatus for inflating an air bag by nitrogen or helium is disclosed in U.S. Pat. No. 3,680,886, a side inflator housing for an air bag using a pressurized gas and a gas generating agent is disclosed in U.S. Pat. No. 5,803,493, and a pressurized gas inflator using argon or nitrogen as a pressurized gas is disclosed in JP-U No. 3031246.

It is demanded that various inflators are reduced in size and weight because of the demands of reducing weight on the vehicle itself, and, additionally, it is demanded to improve workability, simplify the manufacturing process and improve safety at a time of actuation. However, the above related prior arts cannot satisfy all the demands completely.

### DISCLOSURE OF THE INVENTION

An object of the present invention is to provide an inflator with a cap which can achieve reduction in size and weight, can improve workability and can facilitate the manufacturing process, and an air bag apparatus using the same.

The present invention provides, as one means for solving the above-described problem, an inflator with a cap comprising a cylindrical inflator housing which is closed at one end and has an opening portion at the other end and in which the interior is charged with a pressurized medium, a diffuser portion which is fixed to the opening portion side of the inflator housing and is provided with a first gas discharging port for discharging outside the pressurized medium flowing out of the opening portion at a time of actuation, a rupturable plate closing an outflow path for the pressurized medium between the opening portion of the inflator housing and the diffuser portion, and a rupturing means for the rupturable plate provided at the diffuser portion, wherein a cap which covers at least an outer surface including the first gas discharging port and has an opening portion serving as a second gas discharging port is mounted to the diffuser portion by crimping.

By mounting the cap by the crimping in this manner, the manufacturing process can be facilitated as compared with a case of applying welding or the like. Further, when an air bag is attached to the inflator, such an effect can be obtained that the air bag can be connected and fixed by using the crimped portion.

In the above-described invention, preferably, the cap is a barrel-like member which has minimum diameter portions provided at both ends thereof in the longitudinal direction, a maximum diameter portion provided at the central portion thereof in the longitudinal direction and a stepped portion provided between the minimum diameter portion and the maximum diameter portion, the opening portion serving as the second gas discharging port is provided at the stepped portion or the maximum diameter portion, and the cap is mounted to the diffuser portion at the minimum diameter portion.

By providing the second gas discharging ports at the stepped portion, the maximum diameter portion, or both of the stepped portion and the maximum diameter portion, a distributing space for the pressurized medium can be secured between the first gas discharging port and the second gas discharging port, so that discharging of the pressurized medium can not be blocked.

In the above-described invention, preferably, the cap is mounted by crimping one or both of the minimum diameter portions at a groove provided on a peripheral surface of the diffuser portion. It is desirable that the groove provided on the peripheral surface of the diffuser portion is a continuous groove (a ring groove) provided along the peripheral surface.

By mounting the cap in the groove in this manner, the cap can be fixed to the diffuser portion more firmly, and such an effect can also be obtained that, when the air bag is attached to the inflator, it can be connected and fixed thereto by using the groove (the crimped portion).

In the above-described invention, preferably, the total opening area of the second gas discharging ports is larger than that of the first gas discharging ports, and the total opening area of the second gas discharging ports is 1.5 times or more that of the first gas discharging ports.

By defining the total opening areas of the first gas discharging ports and the second gas discharging ports in this manner, a discharging pressure of the pressurized medium can be controlled by the first gas discharging ports.

In the above invention, plural first gas discharging ports are provided, and it is preferable that at least two of the plural first gas discharging ports are disposed at positions symmetrical to each other in the widthwise direction or positions approximating these positions.

In this invention, a cross-section of the diffuser portion in the widthwise direction is circular, and when two or three or more first gas discharging ports are provided, the positions of at least two first gas discharging ports are disposed symmetrically in the widthwise direction (in the radial direction) or nearly symmetrically. It is preferable that, when three first gas discharging ports are provided, three discharging ports are disposed at an equal angle therebetween of 120°, and when four first gas discharging ports are provided, the four discharging ports are disposed at equal intervals, making the angle of 90°. When five or more discharging ports are provided, the ports are disposed in the same manner as the above.

In the event of such an unexpected situation that fire or the like breaks out at a time of transportation/storage of an inflator to cause malfunction thereof, if only one first gas discharging port is provided, the inflator launches like a rocket by the pressurized medium discharged therefrom, which will cause much danger. As described above, however, when arrangement of at least two first gas discharging ports is adjusted, in some cases, when arrangement of three or four or more first gas discharging ports is adjusted, such an abnormal event can be avoided.

In the above invention, by using a cylindrical inflator housing which is symmetrical in the axial and widthwise directions, workability at a manufacturing time can be improved.

Further, the present invention provides, as one means for solving the above problem, an air bag apparatus comprising actuation-signal outputting means comprising an impact sensor and a control unit, and a module case in which the above-described inflator with a cap and an air bag are accommodated in a case.

The inflator of the present invention can facilitate an assembling work and reduce a burden of a worker, and can enhance connection when an air bag is connected.

### BRIEF DESCRIPTION OF THE DRAWINGS

FIG. 1 is a sectional view of an inflator of the present invention in the axial direction, and

FIG. 2 is a view for explaining a method of mounting a cap in the inflator shown in FIG. 1.

### EXPLANATION OF NUMERALS

10 inflator

12 inflator housing

19 rupturable plate

20 diffuser portion

22 first gas discharging port

25 igniter

31 ring groove

40 cap

45 second gas discharging port

### PREFERRED EMBODIMENT OF THE PRESENT INVENTION

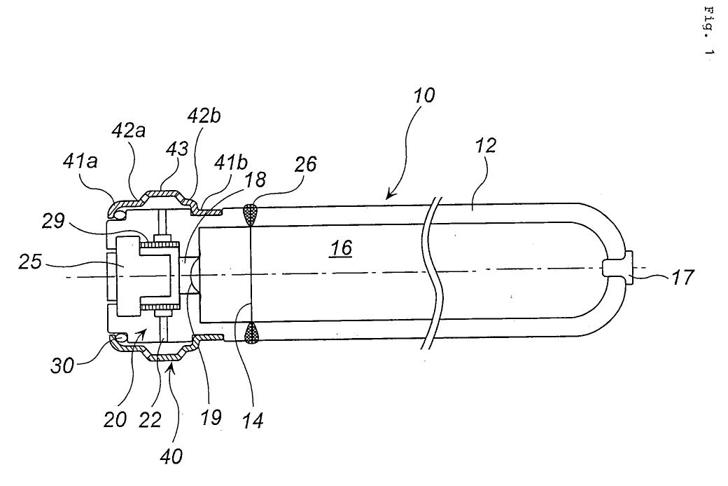

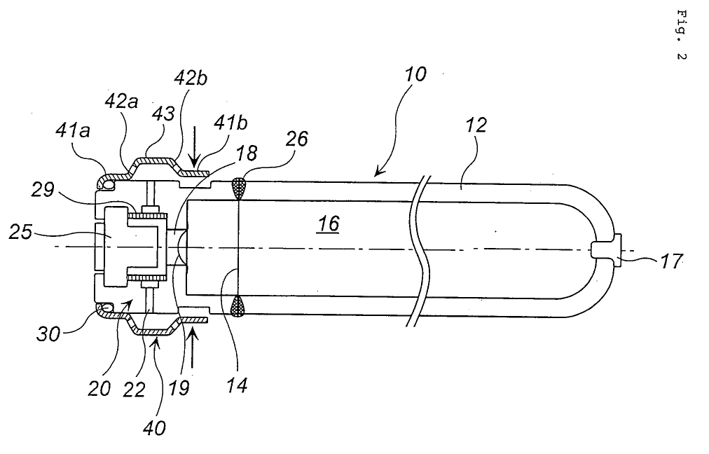

The following is a description of one embodiment on the present invention with reference to the drawings. FIG. 1 is a sectional view of an inflator 10 of the present invention in the longitudinal direction, and FIG. 2 is a view for explaining a method of mounting a cap by crimping.

An inflator housing 12 has an opening portion 14 at one end and the other end side thereof is closed by swaging, spinning or the like. A pressurized medium comprising an inert gas such as argon or helium or nitrogen gas is charged into the internal space 16 formed by the inflator housing 12 and a diffuser portion 20 at the maximum pressure of about 60,000 kPa. A cross section of the inflator housing 12 in the widthwise direction thereof is circular and the opening portion 14 is circular similarly.

The inflator housing 12 can be made symmetrical with respect to the axial direction and the widthwise direction thereof. After the diffuser portion 20 is connected to the inflator housing 12, the pressurized medium is charged from a clearance between a thin hole provided at the closed end surface and a sealing pin 17 fitted into the thin hole, and then the thin hole and the sealing pin 17 are welded to be completely closed.

In the opening portion 14 side of the inflator housing 12, the diffuser portion 20 is connected, and the diffuser portion 20 has a first gas discharging port 22 for discharging the pressurized medium to the outside. The first gas discharging port 22 is not closed, and a screen 29 comprising an annular wire mesh for removing broken pieces of a rupturable plate 19 is disposed inside the first gas discharging ports 22.

The inflator housing 12 and the diffuser portion 20 may be connected to each other by a welding (a welded portion 26) as shown in FIG. 1. Alternatively, they may be connected by screwing a male screw portion provided on an end portion outer peripheral surface of the inflator housing 12 and a female screw portion provided on an end portion inner peripheral surface of the diffuser portion 20.

An outflow path 18 for the pressurized medium inside the diffuser portion 20 is closed by the rupturable plate 19, and the internal space 16 of the inflator housing 12 is kept hermetic with a high pressure before actuation.

An igniter 25 provided with a priming is arranged in the diffuser portion 20, as rupturing means for the rupturable plate 19. The igniter 25 is mounted after the inflator housing 12 and the diffuser portion 20 are connected to each other, and the igniter 25 is fitted in from the opening portion provided at the one end of the diffuser portion 20 towards the rupturable plate 19, and thereafter, it is fixed by crimping a peripheral edge 28 of the opening portion provided at the one end of the diffuser portion 20. The igniter 25 is mounted coaxially with the center axis of the inflator housing 12.

A cap 40 is mounted to the diffuser portion 20, such that it covers an outer surface including the first gas discharging ports 22. The cap 40 is a barrel-like member having the minimum diameter portions 41a and 41b provided at both sides thereof in the longitudinal direction, the maximum diameter portion 43 provided at the central portion in the longitudinal direction, and stepped portions 42a and 42b provided between the minimum diameter portions 41a, 41b and the maximum diameter portion 43. The cap 40 is crimped at the minimum diameter portion 41b to be fixed at a ring groove 31. It is preferable in view of connectability at the time of mounting an air bag that a flat surface or a recess is provided on an outer surface of the minimum diameter portion 41a.

A distributing space 46 comprising an outer peripheral surface of the diffuser portion 20, the stepped portions 42a, 42b, and the maximum diameter portion 43 is formed between the outer peripheral surface of the diffuser portion 20 and the cap 40. For this reason, after the pressurized medium discharged from the first gas discharging ports 22 flows into the distributing space 46, it is discharged from the second gas discharging ports 45 provided at the stepped portions 42a, 42b, so that the pressurized medium is discharged from all the second gas discharging ports 45 by equal amounts.

Since the second gas discharging ports provided at the stepped portions 42a, 42b and the first gas discharging ports 22 do not face each other correctly, the pressurized medium flowing into the distributing space 46 is discharged radially. And, since the discharging direction of the pressurized medium is adjusted according to an inflating and developing direction of an air bag, the second gas discharging ports 22 may be provided on only the stepped portion 42a or only the stepped portion 42b, or they may be provided on only the maximum diameter portion 43. Alternatively, they may be provided on the stepped portions 42a, 42b and the maximum diameter portion 43.

It is preferable that the diameter of the first gas discharging port 22 is made smaller than that of the second gas discharging port 45, which can similarly be applied to the case that plural discharging ports are provided. For this reason, the total opening area of the second gas discharging ports 45 becomes larger than that of the first gas discharging ports 22, and the former is adjusted to be 1.5 times the latter.

As the first gas discharging port 22, it is preferable in view of preventing the inflator 10 from launching like a rocket due to malfunction that two first gas discharging ports 22 are provided symmetrically in the radial direction, for example.

Next, a method for mounting the cap 40 in the inflator 10 will be explained. First, as shown in FIG. 2, the cap 40 is fitted into the diffuser portion 20 from the igniter 25 side to have the minimum diameter portion 41b and the ring groove 31 coincided with each other. At this time, an end portion of the minimum diameter portion 41a abuts on a portion of the diffuser portion 20 near the opening edge 28, and an O-ring 30 is disposed at the abutted portion in order to keep hermetic. Thereafter, as shown in FIG. 1, the cap 40 is fixed to the ring groove 31 by crimping a portion of the minimum diameter portion 41b of the cap 40 in FIG. 2.

An air bag apparatus using the inflator 10 is one constituted by combining actuation-signal outputting means comprising an impact sensor and a control unit, a module case accommodating the inflator 10 and a curtain-like air bag 50 in the case thereof, and the like, and it can be constituted to have the same constitution as shown in FIG. 17 in JP-A 11-334517.

When an air bag is connected to the inflator 10, such a method of connecting can be applied that an opening portion of the air bag covers the cap 40 and is fastened by a fixing band at the ring groove 31 (the minimum diameter portion 41b) at which the cap 40 is crimped. By fixing the opening portion of the air bag at the ring groove 31 in this manner, connection between the air bag and the inflator 10 can be enhanced. Further, by fastening at the minimum diameter portion 41a (where the flat surface or the recess is provided) by a fixing band in the same manner, if required, the connection can further be enhanced.

Next, an operation of the air bag apparatus using the inflator 10 will be explained with reference to FIG. 1. When a vehicle is received the impact, the igniter 25 receives a signal from the impact sensor to be actuated, and the priming is ignited and burnt to rupture the rupturable plate 19. Since the outflow path 18 for the pressurized medium is opened by rupturing of the rupturable plate 19, the pressurized medium in the internal space 16 passes through the outflow path 18 and the filter 29 and then flows into the distributing space 46 through the first gas discharging port 22. Thereafter, the pressurized medium is discharged through the second gas discharging port 45 to inflate the air bag. At this time, broken pieces of the ruptured rupturable plate are removed by the filter 29.

1. An an inflator with a cap comprising a cylindrical inflator housing which is closed at one end and has an opening portion at the other end and in which the interior is charged with a pressurized medium, a diffuser portion which is fixed to the opening portion side of the inflator housing and is provided with a first gas discharging port for discharging outside the pressurized medium flowing out of the opening portion at a time of actuation, a rupturable plate closing an outflow path for the pressurized medium between the opening portion of the inflator housing and the diffuser portion, and a rupturing means for the rupturable plate provided at the diffuser portion, wherein a cap which covers an outer surface including at least the first gas discharging port and has an opening portion serving as a second gas discharging port is mounted to the diffuser portion by crimping.

2. The inflator with a cap according to claim 1, wherein the cap is a barrel-like member which has minimum diameter portions provided at both ends thereof in the longitudinal direction, a maximum diameter portion provided at the central portion thereof in the longitudinal direction and a stepped portion provided between the minimum diameter portion and the maximum diameter portion, the opening portion serving as the second gas discharging port is provided at the stepped portion or the maximum diameter portion, and the cap is mounted to the diffuser portion at the minimum diameter portion.

3. The inflator with a cap according to claim 2, wherein the cap is mounted by crimping one or both of the minimum diameter portions at a groove provided on a peripheral surface of the diffuser portion.

4. The inflator with a cap according to any one of claims 1 to 3, wherein the total opening area of the second gas discharging port is larger than that of the first gas discharging port.

5. The inflator with a cap according to any one of claims 1 to 4, wherein the total opening area of the second gas discharging port is 1.5 times or more that of the first gas discharging port.

6. The inflator with a cap according to any one of claims 1 to 5, wherein plural first gas discharging ports are provided, and at least two of the plural first gas discharging ports are disposed at positions symmetrical to each other in the widthwise direction or at positions approximating the positions.

7. The inflator with a cap according to any one of claims 1 to 6, wherein the cylindrical inflator housing is symmetrical in the axial and widthwise directions.

8. An air bag apparatus comprising actuation-signal outputting means including an impact sensor and a control unit, and a module case in which the inflator with a cap according to any one of claims 1 to 7 and an air bag are accommodated in a case.
